(19) United States
(12) Patent Application Publication
(10) Pub. No.: US 2007/0276713 A1
(43) Pub. Date: Nov. 29, 2007

(54) Method and system for forecasting workforce demand using advance request and lead time

(76) Inventors: Young Min Lee, Old Westbury, NY (US); Daniel Patrick Connors, Pleasant Valley, NY (US)

Correspondence Address: Whitham, Curtis & Christofferson, P.C., 11491 Sunset Hills Road, Suite 340, Reston, VA, 20190, US

(21) Appl. No.: 11/441,194

(22) Filed: May 26, 2006

(51) Int. Cl. G06F 17/50

(52) U.S. Cl. 705/7

(57) ABSTRACT

The present invention forecasts workforce demand by extracting a data set representing project requests that are recorded in a corporate workforce request database before work begins and using advance request data to forecast the future workforce demand. Thus, advance resource request data is accessed, and demand signals are extracted from the data. Forecast models are built for each skill category and forecasting lead time using the advance resource request data. Workforce demand forecasts are also generated.

### BACKGROUND OF THE INVENTION

1. Field of the Invention

The present application generally relates to a computer implemented method and system for forecasting workforce demand and, more particularly, to a method and system which extracts a data set representing project requests that are recorded in the corporate workforce request database prior to the starting date of the work to be done and uses the advance request data to forecast the future workforce demand.

2. Background Description

Service-oriented businesses, including but not limited to business consulting and information technology (IT) outsourcing, comprise one of the fastest growing business sectors, generating a large amount of revenue for many firms. For service-oriented businesses, the lead time for hiring and training a workforce with specific skill sets may be significant, for example, several months in many cases.

This long lead time is potentially problematic, in part because limited visibility into future workforce demand may produce incorrect projections of future workforce needs. Such incorrect projections, in combination with the long lead time, may result in unsatisfactory customer service as a result of delayed fulfillment of customer demand and may even lead to lost business opportunities.

Unforeseen future demand may also increase the cost of recruiting, because conducting hiring activities on an expedited basis may require the services of employment agencies with premium fees. In addition, accurate forecasting of future demand for workers in specific skill categories is important. Inaccurate forecasting may result in employees with one skill set being underutilized or idled (benched) while employees with another skill set find themselves overextended because of a shortage of workers with their skills.

Moreover, skill sets change over time. In IT technology, for example, a new skill set may become an increasingly important resource for the workforce while demand for other skill sets declines. For example, demand for workers with Java programming skills may increase at the same time as demand for workers with COBOL programming skills declines.

An enterprise's limited visibility into future workforce (resource) demand results in limiting actions and reactive fulfillment for workforce-based business. There is a need to improve an enterprise's ability to project customer demand and resource requirement.

Improved customer satisfaction through improved demand fulfillment will result in
Reduced cost of recruiting resources,
Reduced cost of on-boarding/de-boarding resources,
Reduced cost through improved resource utilization, and
Reduced bench level by improved demand management process.

### SUMMARY OF THE INVENTION

The present invention generates very accurate forecast of workforce demand when some of future demand is known in advance. The forecasting method in the invention is a hybrid of multiplicative and additive algorithm, and it outperforms typical time-series modeling as well as multiplicative and additive method used independently.

According to the present invention, there is provided a computer implemented method and system of forecasting workforce demand. The invention uses a Resource Request database that contains various information on projects, requests, positions, status, probability, deployment start data etc. and extracts a data set representing workforce demand prior to the starting date of the work to be done (advance request). The method and system according to the invention categorizes and separates the data set based on actionable skill categories (from, e.g., 1,000 skill descriptions to 20 skill categories, etc.). This data set is sub-divided based on lead time (advance request). Forecasting models (a hybrid of multiplicative and additive algorithms) are developed, each representing a skill category and a lead time, using the advanced request information. The forecasts from each model are merged to forecast overall workforce demand of an enterprise.

Accordingly, the present invention provides a method, a system, and a machine-readable medium with computer instructions for forecasting workforce demand comprising the steps of: accessing Advance Resource Request data; extracting demand signals from the Advance Resource Request data; building forecast models for each skill categories and forecasting lead time using the advance resource request data; and generating workforce demand forecast for various types of workforce. The Advance Resource Request Data may contain workforce related information selected from the group including projects, requests, positions, status, probability, and deployment start data. In addition, the workforce related information may be used to generate a dataset representing advance workforce demand signals. Furthermore, the advance workforce demand signals may be categorized and separated into multiple datasets based on various types of workforce and lead time of advance request, and the forecasting models may be build using advance workforce demand signals and lead times, e.g., 240 separate models if there are 20 skill categories and 12 lead times. Data may be accessed over the Internet or any other network.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a graph showing a typical pattern of workforce deployment of new position starts;

FIG. 2 is a graph showing a typical time series forecasting model using past history;

FIG. 3 is a graph of future demand as recorded in a corporate workforce request database;

FIG. 4 is a graph illustrating the forecasting approach implemented by the present invention;

FIG. 5 is a graph illustrating a system which implements the forecasting method according to the invention;

FIG. 6 is a table illustrating a sample forecast generated by the method and system according to the invention; and

FIG. 7 is an example of a system implemented with a machine-readable medium according the present invention, in which advance resource request data is obtained over a network.

### DETAILED DESCRIPTION OF A PREFERRED EMBODIMENT OF THE INVENTION

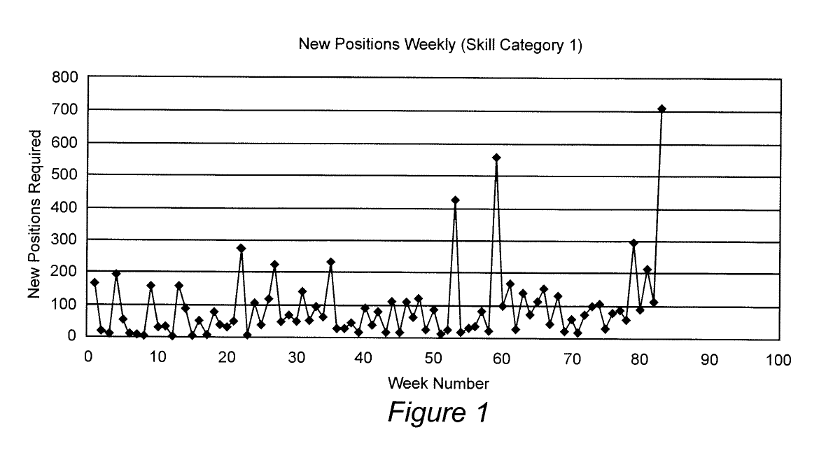

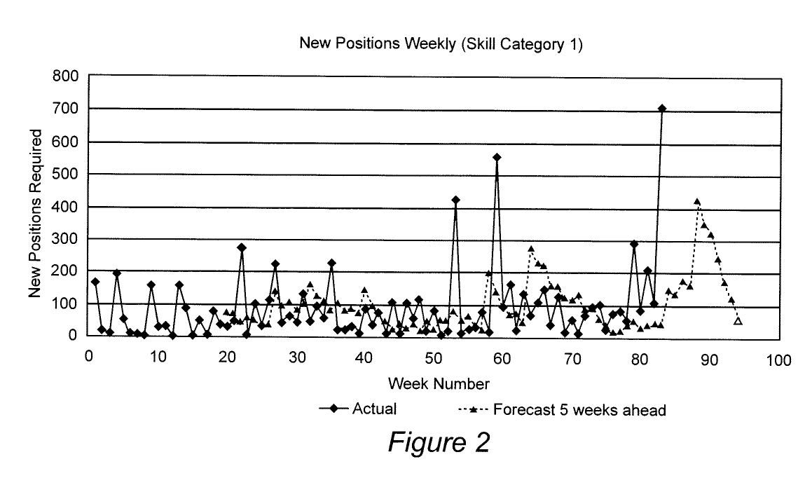

Referring now to the drawings, and more particularly to FIG. 1, A Profile of Workforce Requirements Over Time, there is shown a sample profile of new workforce request in weekly buckets for a service business of IBM Corporation. The profile shows that there is not any particular pattern or trend that can be used for the forecasting future workforce demand. If nothing is known about the future demand of workforce, typically a time-series modeling is applied to use the past history to predict the future. For example, when a double exponential smoothing method is applied to the historic data shown in FIG. 1 to forecast the future demand (5 weeks ahead forecast in this example), the resulting forecast looks like one shown in the dotted curve with triangular markers in FIG. 2, forecast from Time-Series Modeling Versus Actual Workforce. From week 20 to 83 in FIG. 2, the forecasted demand (triangular markers) is compared with the actual demand (diamond markers), and the forecast accuracy is quite poor because there are big discrepancies between the forecasted demand and the actual demand. The volume weighted MAPE (which is a relative error calculation method) for the forecast in this case is 91%.

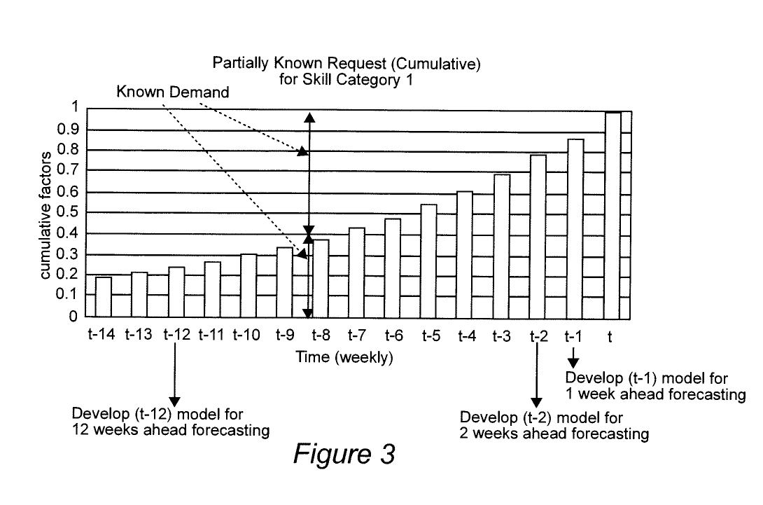

However, workforce demand, fortunately, is partially known in advance because a major part of the orders that require workforce usually comes in before the requested start date. The service buyers typically realize that it take some time for the service provider to acquire a qualified workforce and have them ready for the job. The service buyers also know that a premium can be charged for work request that requires a prompt fulfillment. Therefore, the service buyers would try to place an order with certain lead time. At any point in time, we have a known portion of future demand (advance orders) in a specific future time and unknown portion of the demand. As shown in FIG. 3, Partially Known Demand, the known portion of demand is small when it is farther before the requested service start date, and it gets bigger as the time is closer to the service start date. The relative portion of known demand varies depending on the lead time (how many weeks we are away from the start date) and skill categories.

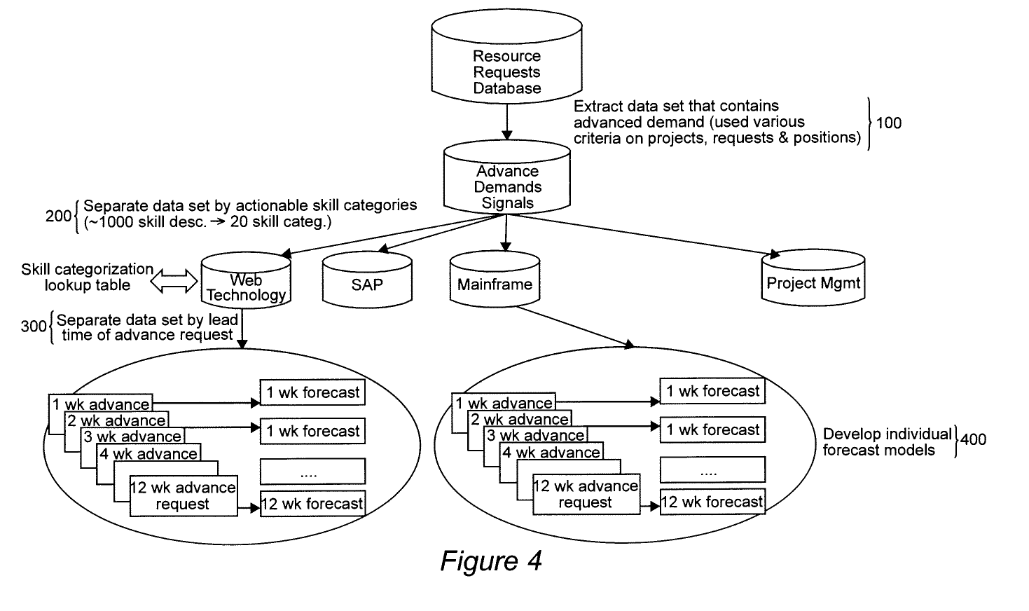

FIG. 4, Overview of Forecasting Method, explains the method of how the workforce demand forecast is generated. The first step is to extract workforce demand that represent firm demand. The Resource Requests Database contains requests for workforce with various characteristics. Some requests are potential requests, some are likely requests, some are partially committed by buyers, some are fully committed and some are just speculation by sales personnel. Each request can be associated with specific projects, requests and positions, which could also have various characteristics. The method extracts a data set that represents advance demand signals for the future that are likely to be fulfilled. Each workforce request also contains information on date it was requested and a start date for the work. The time difference between request date and requested start date are called lead time of advance request.

The second step for the method is to categorize the advance demand signals according to skill categories that are actionable. An actionable skill category is a qualification that a person can possess, and it is possible to look and hire a person with such qualification for example skill in DBMS (Database Management System). Each request typically specifies certain skill descriptions such as C Programmer, SAP APO Programmer, Project Manager and UNIX Administrator, and the number of skill descriptions in a Resource Request Database could be hundreds or thousands. The skill descriptions are categorized into manageable size of skill categories, say 20 etc. The skill categories change over time. The forecasting method used a skill categorization lookup table that categorizes numerous, often more than 1,000, skill sets, into a manageable size of actionable skill categories, often 20 to 30. The skill categorization lookup table has two columns; the first column contains skill descriptions and the second column contains corresponding skill categories. For each request in the Resource Request Database contains skill description, which is matched against the skill categorization lookup table (the first column) to figure out which skill categories it belongs to (second column). All the requests in the database are matched against the lookup table, and are categorized into, say, 20 skill categories. When the content of lookup table changes, the new lookup table is plugged into the system by replacing the old table, and forecast is generated for the new skill categories automatically.

The third step is to separate advance demand signal in each skill categories according to lead time of advance request, in weekly buckets, for instance for 12 weeks.

Each of the resulting subset of advance demand signal is used for computing forecast for a skill category and a forecast lead time. For example, a subset of advance demand signal for a skill category called “Web Technology” and for a lead time of advance request of 1 week is used for computing a forecast for 1 week ahead for workforce with “Web Technology” skill. And, from the lead time of advance request of 2 week is used for computing a forecast for 2 week ahead forecast vice versa. Subsequently, for 20 skill categories and weekly forecast for up to 12 weeks ahead, there would be 240 subsets of advance demand signals, each of which produces a forecast for a specific category for a specific forecast horizon.

The forecast is computed by adding the known portion of demand and unknown portion of demand as the below:

\hat{D}ₜ(k)=Dₜ^{k}+Ĥₜ^{k} ∀k=1,2, . . . , L

### Here, \hat{D}ₜ(k) is forecast of total demand for time t made at k time periods earlier, and

$${D}_{t}^{k} = {\sum }_{i = 0}^{L - k} {D}_{t , L - i}$$

is total accumulated known demand for period t known in period t-k (i.e., k period earlier) where D_{t,k} is un-accumulated demand for period t observed k periods earlier, and L is lead time of forecast, and Hₜ^{k} is demand for period t not known in period t-k (i.e., k periods earlier). And, the unknown portion of demand is computed using linear regression of the known portion of the demand as the below:

Ĥₜ^{k}=aₖ+bₖDₜ^{k}

Here, aₖ and bₖ are regression parameters, and k is forecasting lead time. E.g, k=1 is for 1 week ahead forecast, and k=2 is for 2 weeks ahead forecast. The forecasting models are generated also for each skill categories. Therefore, for 20 categories and 12 (e.g. k=12) lead times, there will be 240 (=20×12) forecast models. One of such model would be a forecasting model that forecasts the demand of SAP programmer 8 weeks from now etc.

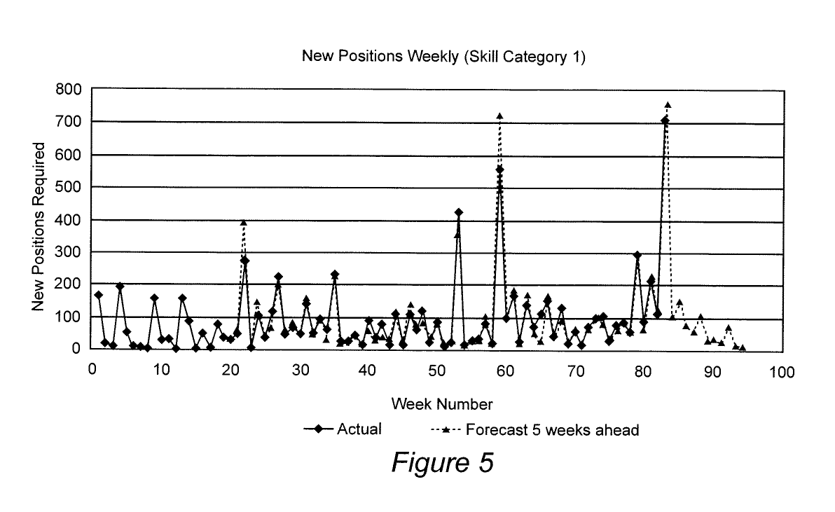

FIG. 5, forecast from the Proposed Method Versus Actual Workforce, shows a forecast profile computed using this method and is compared with actual for the demand data shown in FIG. 1. Here, the forecast is for five weeks ahead and is plotted with triangular markers. From week 20 to 83 in FIG. 5, the forecasted demand (triangular markers) is compared with the actual demand (diamond markers), and the forecast accuracy is quite good. The forecast demand is much closer to the actuals for this method than the time-series based method (FIG. 2). The volume weighted MAPE (which is a relative error calculation method) for the forecast in this case is 24%, which is much better than the forecast done with a time-series model which had a MAPE of 91% as shown in FIG. 2.

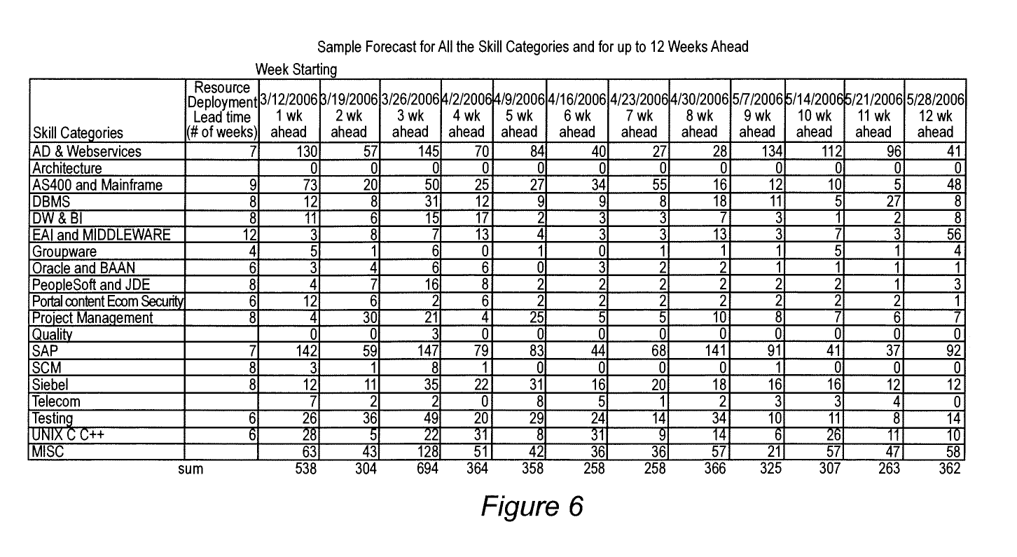

Each forecast for a skill category and a lead time of advance request is assembled together with others to produce the workforce forecasts for all the categories and all the forecast horizons as shown in FIG. 6, Sample Forecast for All the Skill Categories and for up to 12 Weeks Ahead. Each cell of the FIG. 6 represents the forecast computed for a specific skill categories and forecasting lead time. For example, the cell of the column 7 and row 2 contains number 70, which represents the forecasted number of people who have “AD & Webservices” skill, and will be needed for the 5 weeks ahead (week of 4/9/2006) when the forecast was generated on the week of 3/12/2006.

FIG. 7 shows an example of a system according the present invention, in which advance resource request data is obtained over a network. An operator 701 is able to provide input to a computer 760 via a keyboard 741 or a mouse 745, and the computer 760 is able to provide output via a monitor 751 or a printer 755. The computer 760 has a machine-readable medium 770 for providing instructions and which may also store output from the computer. The computer 760 is connected to a network 780 to which is connected a database 790 from which the computer may obtain advance resource request data. Other data may be obtained from, and output may be stored in, other databases 795a, 795b, and 795c connected to the network 780.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer implemented method of forecasting workforce demand comprising the steps of:
accessing advance resource request data;
extracting demand signals from said advance resource request data;
building forecast models for skill categories and forecasting lead time using said advance resource request data; and
generating workforce demand forecast for various types of workforce.

2. The method of claim 1, wherein said advance resource request data contain workforce related information selected from a group including projects, requests, positions, status, probability, and deployment start data.

3. The method of claim 2, wherein said workforce related information is used to generate a dataset representing advance workforce demand signals.

4. The method of claim 3, wherein said advance workforce demand signals are categorized and separated into multiple datasets based on various types of workforce and lead time of an advance request.

5. The method of claim 4, wherein forecasting models are built using said advance workforce demand signals and lead time.

6. The method of claim 1, wherein data is accessed over a network.

7. A system of forecasting workforce demand comprising the steps of:
a computer accessing advance resource request data;
extracting demand signals from said advance resource request data;
building forecast models for skill categories and forecasting lead time using said advance resource request data; and
generating workforce demand forecast for various types of workforce.

8. The system of claim 7, wherein said advance resource request data contain workforce related information selected from a group including projects, requests, positions, status, probability, and deployment start data.

9. The system of claim 8, wherein said workforce related information is used to generate a dataset representing advance workforce demand signals.

10. The system of claim 9, wherein said advance workforce demand signals are categorized and separated into multiple datasets based on various types of workforce and lead time of an advance request.

11. The system of claim 10, wherein forecasting models are built using said advance workforce demand signals and lead time.

12. The method of claim 11, wherein data is accessed over a network.

13. A machine-readable medium for forecasting workforce demand by:
instructing a computer to access advance resource request data;
extract demand signals from said advance resource request data;
build forecast models for each skill categories and forecast lead time using said advance resource request data; and
generate workforce demand forecast for various types of workforce.

14. The machine-readable medium of claim 13, wherein said advance resource request data contain workforce related information selected from a group including projects, requests, positions, status, probability, and deployment start data.

15. The machine-readable medium of claim 14, wherein said workforce related information is used to generate a dataset representing advance workforce demand signals.

16. The machine-readable medium of claim 15, wherein said advance workforce demand signals are categorized and separated into multiple datasets based on various types of workforce and lead time of an advance request.

17. The machine-readable medium of claim 16, wherein forecasting models are built using said advance workforce demand signals and lead time.

18. The machine-readable medium of claim 13, wherein data is accessed over a network.
